(19) United States
(12) Patent Application Publication
(10) Pub. No.: US 2007/0035855 A1
(43) Pub. Date: Feb. 15, 2007

(54) Miniature confocal optical device, system, and method

(76) Inventor: David L. Dickensheets, Bozeman, MT (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/547,202

(22) PCT Filed: Mar. 3, 2004
(86) PCT No.: PCT/US04/06333

§ 371 Date: Oct. 11, 2006

Related U.S. Application Data
(60) Provisional application No. 60/451,524, filed on Mar. 3, 2003.

(51) Int. Cl. G02B 7/02

(52) U.S. Cl. 359/819

(57) ABSTRACT

A confocal optical device is described. The device includes a tri-axial scanning mirror that can provide for three-dimensional scanning of objects. In particular, the scanning mirror has a deformable reflective membrane mounted on two annular gimbaled members to provide for rotation about two orthogonal axes. The deformable membrane, which can be provided at other suitable locations in the device, is used to control the focusing spot of the light beam transmitted from the device to the object being scanned. Various methods relating to the confocal optical device are also described.

### PRIORITY

This application claims the benefit of priority of U.S. Provisional Patent Application Ser. No. 60/451,524, filed on 3 Mar. 2003, the complete and entire disclosure of which is specifically incorporated by reference into the present application.

### FIELD OF THE INVENTION

This invention relates generally to an optical scanning device. In one aspect, the invention relates to an optical three-dimensional confocal type-scanning device. In another aspect, the invention also relates to a miniature confocal microscope probe and system. In addition, this invention also relates to various components of the confocal microscope probe. Additionally, this invention relates to a method of controlling a focusing spot of an optical system. Further, this invention also relates to a method of scanning objects.

### BACKGROUND OF THE INVENTION

A conventional microscope can be used for viewing specimens by enlarging the image of such specimens. Although the optical microscope is suitable in some applications, it is believed that such microscope may be disadvantageous in applications that require a study of thick-layered specimens of greater than 2 millimeters. In such applications, glare caused by out-of-focus portions of the image is prevalent. Further, a deep field of view of the microscope may interfere with the ability to study discrete layers of the specimen, and the optical microscope may not be able to provide an image of optical sections of the thick specimens. Where fluorescence dyes are used with the optical microscope, secondary fluorescence for various portions of the specimen that are out-of-focus often interfere with the portions or sections that are in-focus, thereby rendering an image of the section of interest virtually unsuitable for use in research.

To overcome these and other disadvantages of the optical microscope, a different type of microscope was developed using a combination of objective lens, scanning mirrors, high-intensity light source, and photo-detector. Typically, confocal microscopes also include optical elements such as pinholes and also include some form of processor, such as a microprocessor-based computer or similar device. Principally, in this type of microscope, the point at which an image is formed is “conjugate” to the point at which the objective lens is focused (i.e., the “focal” point). Hence, this type of microscope is identified as a “confocal” microscope. The principle of operation of such microscope is illustrated as shown in FIG. 9A. In this figure, the image point (e.g., CP1 or CP2) is “conjugate” to the “focal” point (FP1 or FP2).

One notable advantage of the confocal microscope is the ability of the device to reject light from out-of-focus regions. For the purpose of explaining the principal operation of a confocal microscope, a schematic representation of such device is shown in FIG. 9A. In FIG. 9A, section A of the specimen is at focal point FP1 so that an image of section A via light-ray line 1 is in-focus at conjugate point CP1, whereas section B at FP2 (at conjugate point CP2) is out-of-focus. Assuming that there is no pin-hole PH, then the image formed by ray-line 2 (which is out-of-focus compared to ray-line 1) would interfere with the image formed via light-ray line 1 at CP1 such that some of the light from section B may be directed to conjugate point CP1 and the light intensity measurement at section A may be affected. Where the light intensity from conjugate point CP1 is very low, the light from conjugate point CP2 may produce an artificially high measure of the intensity at conjugate point CP1. This may reduce the dynamic range of the image and affect its “sharpness.” By providing the pin-hole, the microscope of FIG. 9A is able to achieve a selection of the conjugate focal point CP1 while rejecting light from out-of focus conjugate point CP2. This can help alleviate image capture limitations that may be caused by light from locations other than conjugate point CP1.

In known applications of the confocal microscope, as shown schematically in FIG. 9B, a light source LS, pin-hole PH1, dichroic mirror DM, scanning mirror SM, photo-detector PD, pin-hole PH2, and objective lens OL are used to scan a laser light LS across the specimen SP. The laser light source LS is used to provide a high-intensity light and directed through both the dichroic mirror DM and objective lenses OL. A desired focal point FP can be achieved by moving either the light source LS or by changing the focusing of the objective lens OL. The reflected laser light LS is directed back to the scanning mirror to the dichroic mirror DM that permits a portion of reflected light to pass through to the photoreceptor PD. Because only a general area at and around a focal point (i.e., a generally circular area known as an “Airy” disc) can be viewed at a time, a complete image of the specimen must be electronically constructed by scanning across multiple focal points of the specimen SP with the scanning mirror SM. That is, to form an image, the confocal microscope utilizes a computer to construct a graphical image by scanning the light source across a stationary specimen or by moving the specimen across a stationary light source. By constructing the image electronically, the confocal microscope can generate a two or even a three-dimensional image of the specimen on a computer graphical display or paper output.

The known confocal microscopes are extremely useful in research because they span the image-resolution gap between an electron microscope and the optical microscope. This has allowed researchers in several fields to use confocal microscopes for imaging living systems such as, for example, in vivo imaging. However, the conventional confocal microscopes are believed to be bulky and complex for use inside a laboratory.

To overcome these shortcomings, a miniaturized confocal microscope was developed. This miniature confocal microscope, as described in U.S. Pat. No. 5,907,425, combined a silicon micromachined mirror to produce sub-millimeter precision scan mirrors, with binary optics technology to produce a sub-millimeter objective lens. The scanning head portion of the prototype confocal laser scanning microscope measured less than 1.2 mm thickness×2.5 mm width×6.5 mm length, yet achieved image resolution better than 1 μm with a numerical aperture (“NA”) of 0.25. This confocal microscope was packaged to provide focus control by moving both the light source and scanning mirror within a housing in the form of a hypodermic tube of only 3.4 mm in outside diameter. Its 50 millisecond image acquisition time reduced motion artifacts, and micrometer resolution was routinely achieved when acquiring images with the instrument being handheld, provided the instrument was in contact with the surface being imaged.

That first demonstration or prototype instrument represented a significant advance in the field of miniature precision optical instruments. This has led to a fundamental paradigm shift in high-resolution optical microscopy. Rather than taking the sample from its native environment, i.e., in-vivo for imaging at the microscope, one can take the miniature confocal microscope to the sample environment, in-situ.

The prototype miniature confocal microscope, however, was still not a practical device for routine use in the biological laboratory or even outside the laboratory. The packaging of the prototype was relatively large, e.g., at greater than about 3 millimeters in outside diameter. The image formed was monochromatic, and the instrument was not configured to acquire a fluorescence image because of the extreme dispersion of the binary optic lens, and the numerical aperture was low for efficient fluorescence imaging. Also, an obstacle to routine use of the prototype, however, was the cumbersome optical and electronic interface that required an expert user to operate, and the lack of real-time image display and control.

Prior to a discussion of a summary of the invention, it is worth noting that all publications and patent applications described herein are incorporated by reference to the same extent as if each individual publication or patent application was specifically and individually indicated to be incorporated by reference. It is not an admission that any of the information provided herein is prior art or relevant to the presently claimed inventions, or that any publication specifically or implicitly referenced is prior art.

### SUMMARY OF THE INVENTION

In one aspect of the invention, a confocal optical device is provided. The device comprises a light source, at least one objective lens, a unitary member, and at least one actuator. The at least one objective lens is proximate the light source. The unitary member is proximate the light source. The unitary member has an outer portion and an inner portion. The inner portion is connected to the outer portion, and the inner portion has a deformable surface. The at least one actuator is configured to deform at least a portion of the deformable surface into a curved sectional surface, and to move the inner portion relative to the outer portion upon energization of the at least one actuator.

According to an alternative aspect of the invention, the device comprises a light source, at least one objective lens, a unitary member, and at least one actuator. The at least one objective lens is proximate the light source. The unitary member is proximate the light source. The unitary member has an outer portion and an inner portion. The inner portion is connected to the outer portion, and the outer portion has a maximum cross-sectional area of less than about 9 squared millimeters. The inner portion has a deformable surface. The at least one actuator is configured to deform at least a portion of the deformable surface into a curved sectional surface, and to move the inner portion relative to the outer portion upon energization of the at least one actuator.

According to yet another alternative aspect of the invention, the device comprises a housing, a light source, at least one objective lens, and a member. The housing extends along a longitudinal axis between first and second ends. The light source transmits a light beam towards the second end. The at least one objective lens is disposed in the housing proximate the second end. The at least one objective lens has a reflective portion that directs the light beam from the light source towards the first end. The member is disposed between the light source and the at least one objective lens. The member has a reflective portion that defines a curved surface with respect to the longitudinal axis in an operative position of the member.

According to a further embodiment, the device comprises a housing, a light source providing a light beam, and means for moving the light beam to a plurality of focal positions laterally and axially on a focal axis defined by the light beam.

According to another alternative aspect of the invention, the device comprises a housing, a light source, at least one objective lens, and a member. The housing extends along a longitudinal axis between first and second ends. The light source transmits a light beam towards the second end. The light source is fixed at a first location in the housing. The member is disposed between the light source and the at least one objective lens. The member has a deformable reflective portion. In a first operative position, the deformable reflective portion directs the beam through the at least one objective lens to define a first focal point of light away from the housing along a focal axis. In a second operative position, the deformable reflective portion directs the beam through the at least one objective lens to define a second focal point of light on the focal axis.

According to an additional embodiment, the device comprises a housing, a light source, at least one objective lens, and a member. The housing extends along a longitudinal axis between first and second ends. The light source transmits a light beam towards the second end. The light source is fixed at a first location in the housing. The at least one objective lens is disposed at a fixed location in the housing proximate the second end. The member is proximate the second end. The member has a deformable reflective portion. In a first operative position, the deformable reflective portion reflects the directed beam through the at least one objective lens to define a first focal point of light away from the housing on a focal axis defined by the directed beam. In a second operative position, the deformable reflective portion reflects the directed beam through the at least one objective lens to define a second focal point of light on the focal axis.

According to another alternative aspect of the invention, the device comprises a housing, a light source providing a light beam, and a means for moving the light beam. The housing extends along a longitudinal axis between first and second ends. The housing has a maximum cross-sectional area with respect to the longitudinal axis of less than about 9 millimeters-squared. The means for moving the light beam move the light beam to first and second focal points on a focal axis defined by the beam of light.

According to yet another alternative aspect of the invention, the device comprises a housing, a light source, and at least one objective lens. The housing extends along a longitudinal axis between first and second ends. The housing has a maximum cross-sectional area with respect to the longitudinal axis of less than about 9 millimeters-squared. The light source transmits a light beam towards the second end. The at least one objective lens is disposed in the housing proximate the second end. The at least one objective lens includes one diffractive lens and one refractive lens.

According to a further alternative aspect of the invention, the device comprises an input portion, a focusing portion, and a housing. The input portion transmits a light beam through the input portion. The focusing portion moves the light beam at a plurality of focal positions on a focal axis defined by the light beam. The housing extends along a longitudinal axis between first and second ends to enclose the input and focusing portions. The housing has a maximum cross-sectional area with respect to the longitudinal axis of less than about 9 millimeters-squared.

In another aspect of the invention, a dynamic lens is provided. The dynamic lens comprises a unitary member and at least one actuator. The unitary member has an outer portion and an inner portion. The inner portion is connected to the outer portion. The inner portion has a deformable surface. The at least one actuator deforms at least a portion of the deformable surface into a curved sectional surface, and moves the inner portion relative to the outer portion upon energization of the at least one actuator.

According to an alternative aspect of the invention, a dynamic lens is provided. The dynamic lens comprises an outer portion, an optical inner portion, and at least one actuator. The optical inner portion is connected to the outer portion. The optical inner portion has a base portion and a deformable portion spaced apart along an axis. The base portion includes a first base surface spaced apart from a second base surface with a first wall portion connecting the first and second base surfaces. The wall portion is disposed about the axis to define a first aperture. The deformable portion includes a first surface spaced apart from a second surface along the axis with a second wall portion connecting the first and second surfaces. The second wall portion is disposed around the axis to define a second aperture generally aligned with the first aperture. The at least one actuator is contiguous to the first surface of the deformable portion so that energization of at least the one actuator deforms the first surface into a curved solid sectional surface.

In another aspect of the invention, a confocal optical system is provided. The confocal optical system comprises a photodetector, a light source, an optical fiber, and a confocal optical probe. The photodetector generates signals to a graphical display based on detection of light. The optical fiber has a first end and a second end. The first end is in communication with the light source. The confocal optical probe is in communication with the light source. The confocal optical probe includes a housing, a base structure, and at least one objective lens. The housing extends along a longitudinal axis between first and second ends. The housing has a maximum cross-sectional area with respect to the longitudinal axis of less than about 9 millimeters-squared. The base structure is connected to the second end of the optical fiber. The base structure extends along the longitudinal axis in the housing and locates the second end of the optical fiber at a fixed location in relation to the housing. The at least one objective lens is located in the housing in a fixed position proximate the second end. The at least one objective lens has a reflective portion that directs a light beam of the light source through the optical fiber towards the first end of the housing as a directed beam of light.

In another aspect of the invention, a method of controlling a focus of an optical device is provided. The method comprises providing a light source with an objective lens fixed in relation to each other and a housing so that a light beam from the light source along a longitudinal axis converges through the objective lens to a focal point on a focal axis, and translating the focal point along the focal axis.

In another aspect of the invention, a method of scanning an object is provided. The method comprises establishing a fixed relationship between a light source, objective lens and a housing of an optical device so that a light beam from the light source converges through the objective lens to a focal point along a focal axis, and translating the focal point along the focal axis during a first time interval.

Other advantages and features of the present invention are apparent to one skilled in the art upon reviewing the specification and the drawings provided herein. Thus, further features and advantages of the present invention will be clear from the description that follows.

### BRIEF DESCRIPTION OF THE DRAWINGS

FIG. 1 illustrates a cross-sectional view of a confocal microscope system according to a preferred embodiment;

FIG. 2 illustrates a first preferred embodiment of a micro-confocal probe usable in the system of FIG. 1;

FIG. 3 illustrates a second preferred embodiment of a micro-confocal probe usable in the system of FIG. 1;

FIG. 4 illustrates an exploded view of the probe of FIG. 2;

FIGS. 5A-5C illustrate, respectively, plan, end and side views of a ferrule and associated components;

FIGS. 6A-6C illustrate, respectively, end and two different sectioned views of the nano-machined scanning mirror of FIG. 5C;

FIGS. 7A and 7B illustrate, respectively, half-sectioned view of a micro-machined mirror in one operative condition, and a half-sectioned view of the micro-machined mirror in another operative condition;

FIG. 8A illustrates a side view of a preferred multi-element objective lens for the probe of FIG. 2;

FIGS. 8B-8C illustrate the performance parameters of the preferred multi-element objective lens; and

FIGS. 9A and 9B illustrate, respectively, the principle operation of the confocal microscope in general, and a schematic of a known confocal microscope.

### DETAILED DESCRIPTION

Unless defined otherwise, all technical and scientific terms used herein have the same meaning as commonly understood by one of ordinary skill in the art in related technical fields.

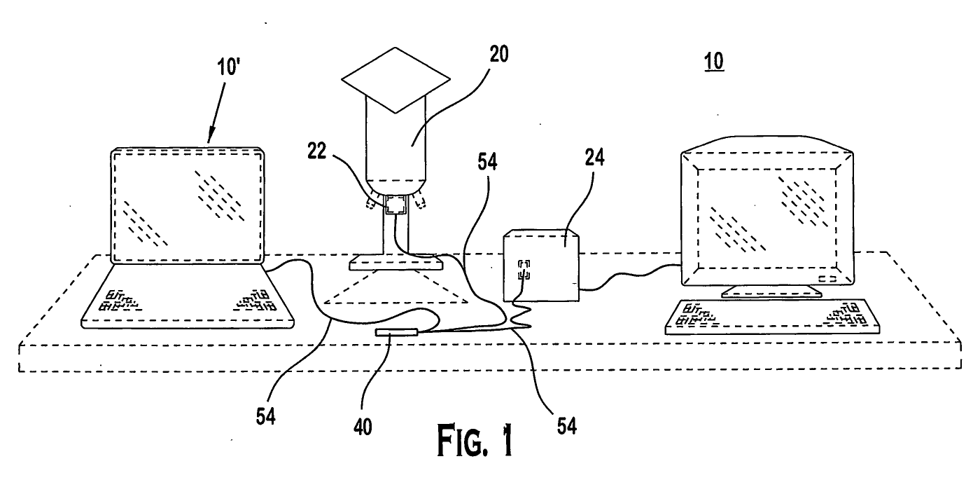

FIGS. 1-8 illustrate preferred embodiments. In particular, FIG. 1 illustrates one example of a confocal optical system 10. The system 10 can include a photodetection unit 20 and graphical display unit 30 coupled to a confocal microprobe 40. The microprobe 40 can be coupled to the photodetection unit 20 via an optical interface 22, such as, for example, an optical fiber type beam splitter, which is further coupled to the display 30. The microprobe 40 can be controlled by an electrical interface 24. Although the system 10 is shown as a desktop unit, the components of the system 10 can be configured into portable or handheld systems 10′.

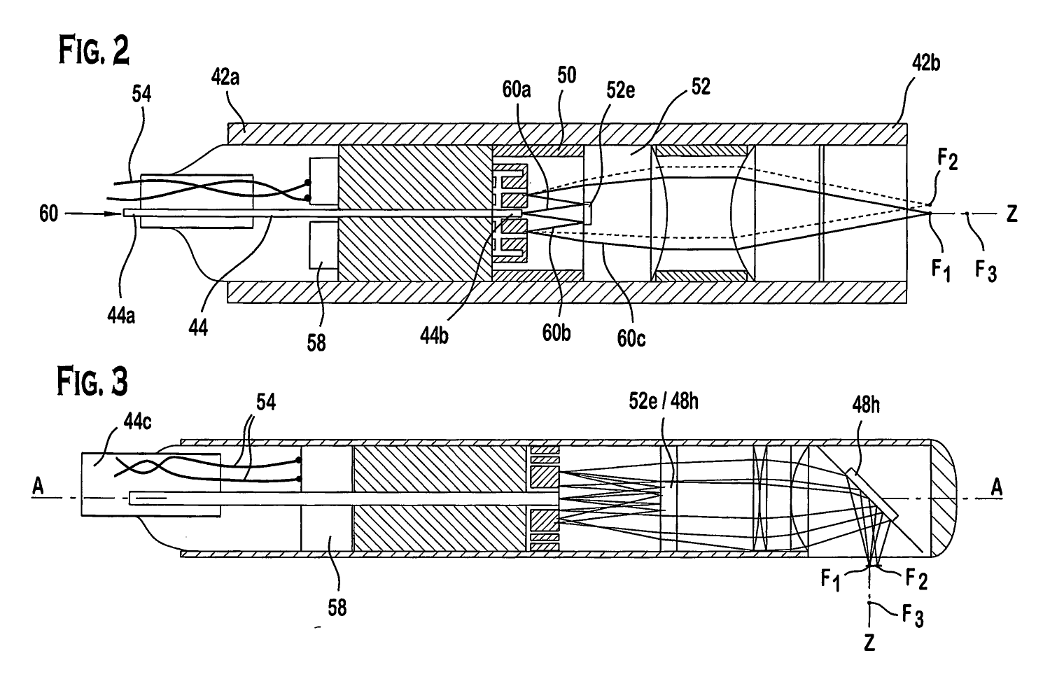

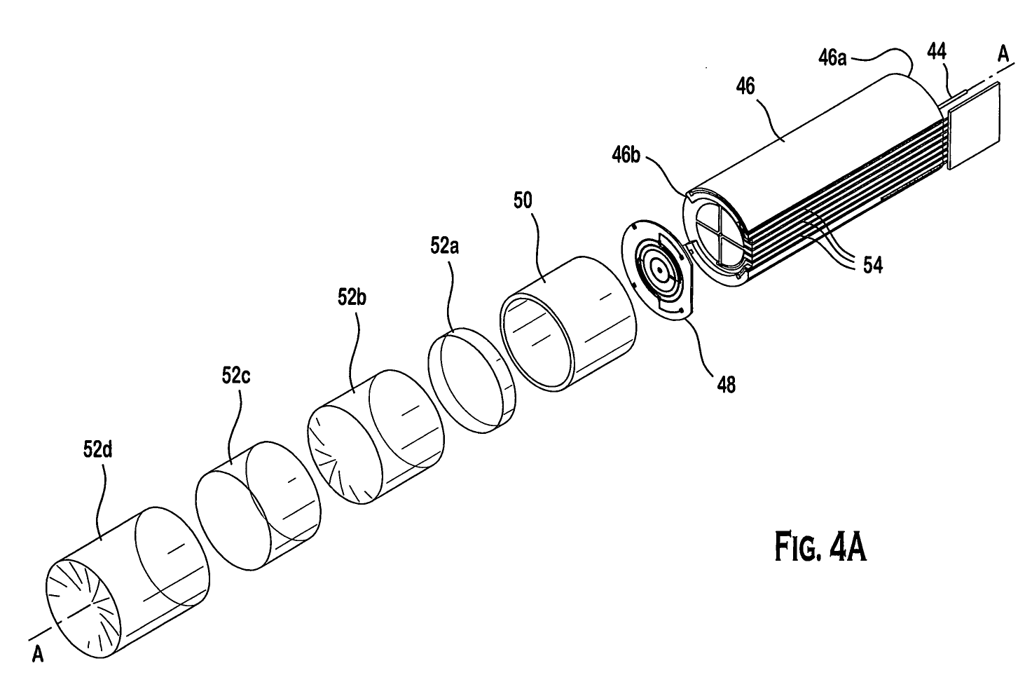

Referring to FIG. 1, the microprobe 40 can be configured in at least two different arrangements, shown exemplarily here as FIGS. 2 and 3. Although the two arrangements can be configured for specific end-user applications, the respective elements shown in both arrangements have generally similar functions. Thus, the same reference numerals will denote common elements interchangeable between the two embodiments, and significant differences will be noted textually.

In the preferred embodiments, each of the preferred embodiments of the microprobe 40 can include a probe housing 42 that extends along a longitudinal axis A-A (FIG. 4A) between first housing end 42a and second housing end 42b. The probe housing 42 has an outer diameter of less than 3.4 millimeters. However, other shapes can be utilized, though it is preferred that the maximum cross-sectional area of the housing 42 not exceed about 9 millimeters-squared with respect to the longitudinal axis A-A. And although the axis A-A is shown as coincident with a Z-axis of a scanning mirror 48a or the focused light beam emanating from the objective lens, it is noted that they are not necessarily the same axis, depending on the operation of the scanning mirror assembly 48.

As shown in FIG. 4A, the probe housing 42 encloses a portion of a fiber optic cable 44, ferrule 46, scanning mirror assembly 48, spacer 50, and at least one objective lens 52 with a retro-reflecting mirror 52e provided on the lens 52. These components are preferably arranged symmetrically on the longitudinal axis A-A. While these components have been shown and described as separate members, one or more of the components can be formed unitarily as a single component. For example, the objective lens 52 can be formed from a suitable glass or polymeric material as a unitary part of the housing 42.

In the first preferred embodiment of FIG. 2, the microprobe 40 is configured for frontal imaging (“end-face viewing”) with a housing that has an outer diameter of about 1.5 millimeters and whose length is about 10 millimeters along the longitudinal axis A-A. In the second preferred embodiment of FIG. 3, the microprobe 40 is configured for side imaging by virtue of a reflector 53 with a housing that has an outer diameter of about 1.8 millimeters and whose length is about 10 millimeters along the longitudinal axis A-A. As configured in the preferred embodiments, light 60 is transmitted by the optical fiber 44 to an aperture 56 (e.g., pin-hole) so that a light beam 60a is directed to retro-reflecting mirror 52e. Retro-reflecting mirror 52e reflects some portion or all of light beam 60a as a redirected beam 60b to the scanning mirror assembly 48. The scanning mirror assembly 48 reflects some or all of the redirected beam 60b as objective light beam 60c through the objective lens to converge on a focal point F1. And although the length has been described as preferably 10 millimeters, other suitable lengths can be utilized such as, for example, by reducing the length of the microprobe 40 via a reduction in the number of objective lenses while maintaining the necessary parameters for its operation.

Referring to FIG. 4A, the fiber optic cable 44 can be a single-mode or multi-mode optical fiber 44 with a suitable core size depending on the applicable wavelength of light being transmitted therethrough between a first fiber end 44a and second or terminal end 44b. Where a multi-mode optical fiber 44 is used, differential imaging can be obtained based on the number of modes being transmitted therethrough. In one preferred embodiment, the optical fiber 44 is a single mode optical fiber 44 so that the single mode fiber can illuminate an object. This single mode fiber 44 can be surrounded by a dual-mode optical fiber 44 to detect reflected light from the specimen, i.e., a double-clad optical fiber. In one embodiment, the optical fiber 44 is a single-mode optical fiber for both transmitting and receiving, where the fiber 44 has a core size of about 6 microns with a numerical aperture of about 0.13 to transmit light at wavelength of about 488 nanometers. Other embodiments may include other dimensions, including dimensions appropriate to support operation at more than one wavelength. For example, in one approach wavelengths of red, green, and blue may be appropriate. The optical fiber 44 can disposed within a protective tubular member 44c that also carries the electrical connectors for the actuators of the scanning mirror. As used herein, the terms “about” or “generally” denotes a suitable level of tolerance or variation of the confocal optical device or its components, which would allow the device or its components to function as an optical imaging device.

As shown in an exploded view of FIG. 4A, ferrule 46 has first ferrule end 46a and second ferrule end 46b extending along longitudinal axis A-A. In a close-up view of the ferrule 46 in FIG. 4B, the ferrule 46 preferably has a polygonal cross-section 46c with a planar portion 46d extending orthogonal to the cross-section 46c along the longitudinal axis A-A to provide a mounting surface for control circuits or communication wires 54 for actuators 46e-46h and actuators 48c and 48g and ground connection for scan mirror elements 48e and 48i. One or more boss portions 46j, 46k can be formed on the surface 46c so as to provide a gap 46i between the scanning mirror assembly 48 and the actuators 46e-46h. The ferrule 46 can be formed unitarily or joined together by a suitable non-conductive or semi-conductive material that has sufficient stiffness, such as, for example, non-metals, silicon, ceramic, glass or various combinations of these materials. Preferably, the ferrule 46 is a combination of ceramic and glass.

Although the probe housing 42 has been shown in a coaxial arrangement with at least one of the fiber optic cable 44, ferrule 46, scanning mirror assembly 48, and at least one objective lens 52, other application-specific arrangements can also be used in which the housing 42 and at least one of the components of the probe 40 are non-coaxial. Preferably, the housing 42 is coaxial with the fiber optic cable 44, ferrule 46, mirror assembly 48, and at least one objective lens 52. Also preferably, the housing 42 of probe 40 is polymeric with a generally circular cross-section generally transverse to the longitudinal axis A-A with an outer diameter of less than 3.4 millimeters, and more particularly, less than 2.0 millimeters for a maximum cross-sectional area of less than about 9 millimeters-squared. Other geometrical shapes of the probe housing 42, however, can be used. In the preferred embodiment, the cross-section of the housing 42 of probe 40 extends generally along the longitudinal axis A-A to define a cylindrical volume of about 25 cubic millimeters.

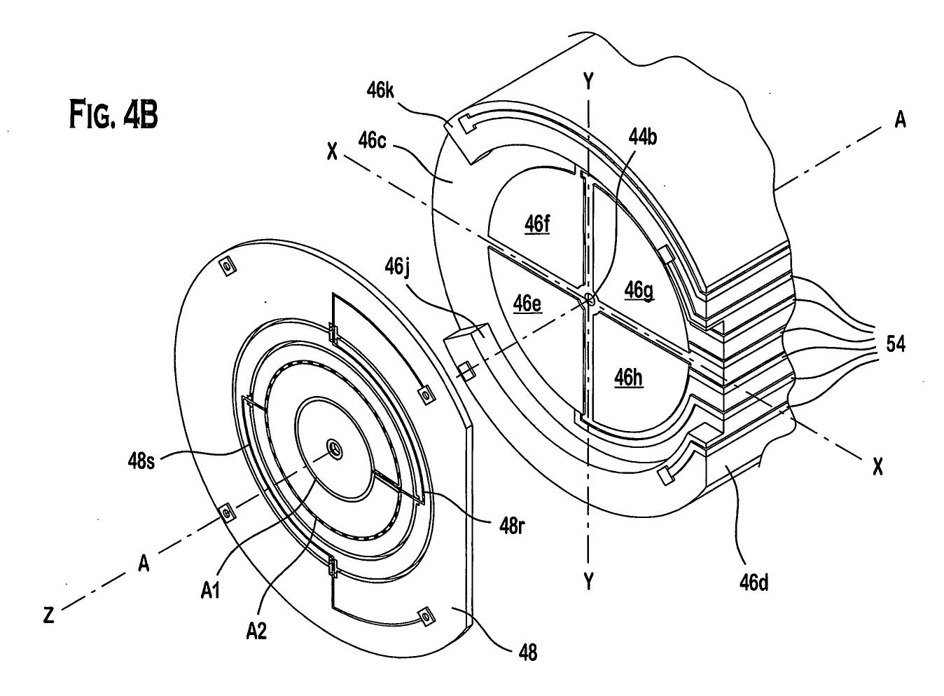

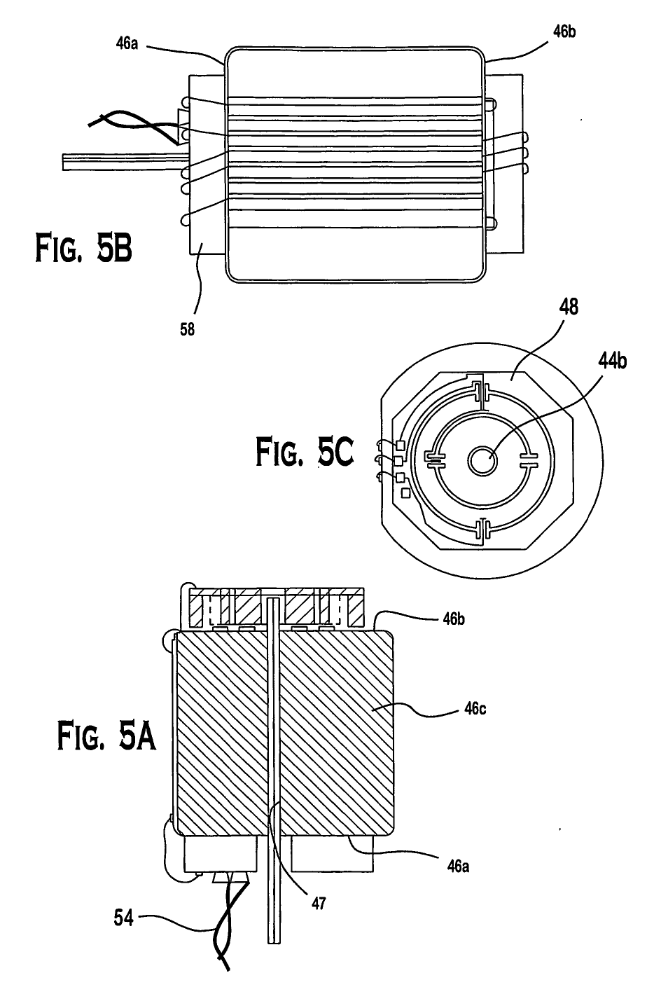

As shown in FIGS. 5A and 5B, the ferrule 46 includes first ferrule end 46a and second ferrule end 46b connected by ferrule wall 46c. The ferrule wall 46c has wall surface 47 that forms an aperture 56 extending through the ferrule 46 along the Z-axis. The aperture 56 can be a generally cylindrical through-hole of a diameter typically ranging from 10 microns to 125 microns, and preferably 75 microns. The first ferrule end 46a of the ferrule 46 can include a circuit board 58 that controls or interfaces with various components of the probe 40 and the electrical interface 24. Electrical connections can be formed on the planar surface 46d of the ferrule 46 (which forms a D-shaped cross-section) by a suitable technique, such as, for example, etching or vapor depositions. The second ferrule end 46b can be a generally planar end face 46c with a mirror 48a mounted on the end face 46c with a suitable technique, such as, for example, bonding or gluing. And although an optical fiber 44 is shown in the preferred embodiments that transmits and receives light, a laser source can be located in the aperture 56 instead of the optical fiber 44. Alternatively, a combination of a laser source and a suitable photodetector can be located in the aperture 56 proximate to the second ferrule end and distal to the first ferrule end. As used herein, the term “photodetector” means a suitable light detection device such as, for example, a photomultiplier or photodiodes (e.g., silicon photodiodes). While the “light source” is preferably a laser source, other light sources of sufficient power density may be appropriate in some applications. Moreover, the light source can include, but is not limited, to light in the visible or non-visible light (e.g., to the human-eye) such as, for example, 200 nanometers to about 3 microns. And the light (e.g., visible or invisible to the human eye) is not limited to a specific wavelength and can be a combination of various wavelengths.

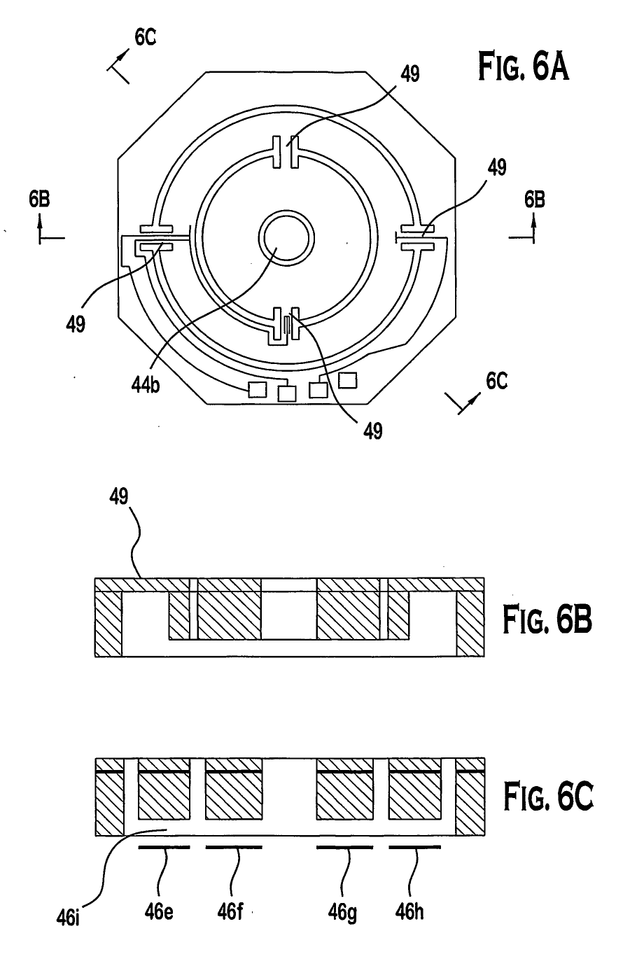

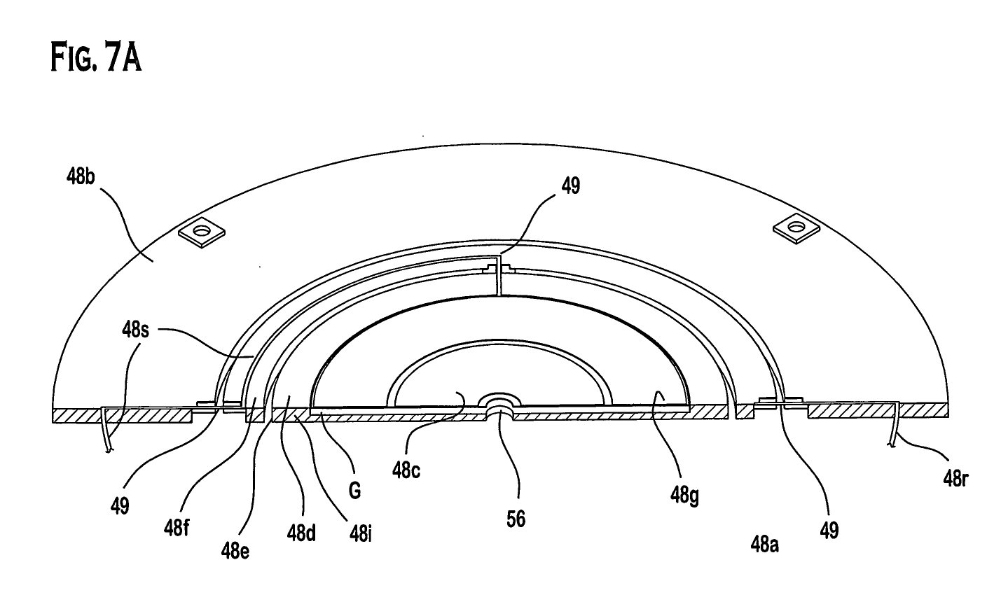

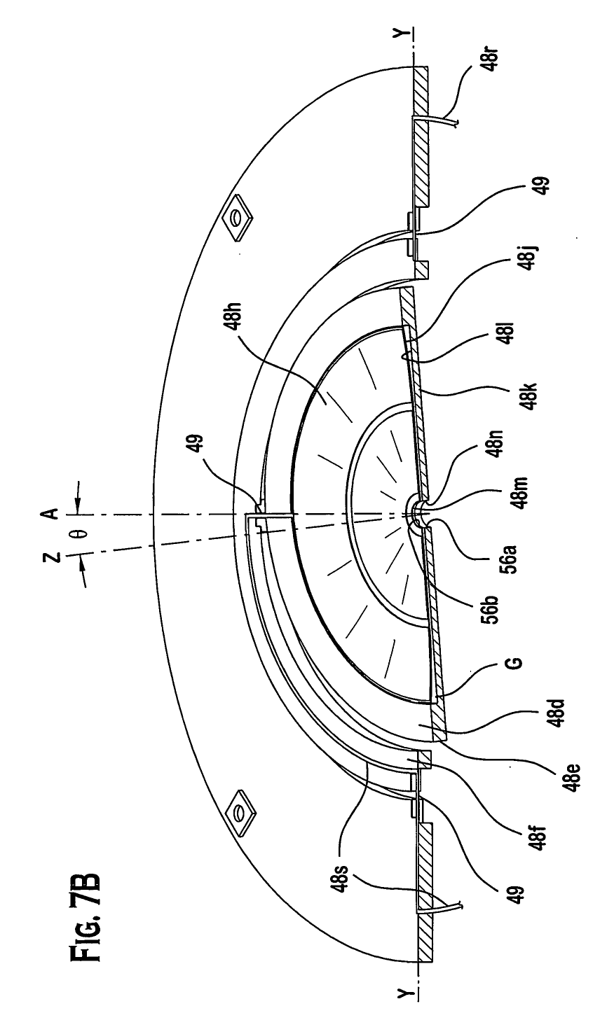

As shown in FIGS. 6C and 7A, the scanning mirror assembly 48 preferably has a support surface 48b on which scanning mirror 48 is supported. The scanning mirror 48a can be formed to provide two mirror portions 48c and 48d in a generally concentric arrangement. Both mirror portions 48c and 48d are supported by a gimbaled plate member 48e. Mirror 48a rotates via a first set of diametrically disposed beam members 49 about the X-X axis, i.e., a tipping axis relative to the support surface of the scanning mirror assembly 48. The gimbaled plate member 48e is supported by a second set of diametrically disposed beam members 49 (FIG. 6B) and rotates about the Y-Y axis, i.e., a tilting axis relative to the support surface of the scanning mirror assembly 48. As shown in FIG. 7B, the mirror 48a is shown as rotating about the tipping axis X-X so that the axis Z of the mirror 48a is tilted over an included angle θ relative to the longitudinal axis A-A. Similarly, the mirror 48a can also rotate about the tilting axis Y based on the gimbaled arrangement (not shown in FIG. 7B for clarity). By virtue of this arrangement, the mirror 48a can rotate in two axes to move a focal point F1 to F2 of a light beam in two axes and provide for two-dimensional scanning (FIGS. 2 and 3) of the focal point of the light beam through the at least one objective lens 52. Preferably, the outer diameter of the scanning mirror assembly is about 700 microns.

Furthermore, as shown in FIG. 2, the scanning mirror assembly 48 can also be configured to move the focal point F1 along a third axis defined by the light beam, i.e., the Z axis, to a different focal point F3, to provide for three-dimensional scanning without requiring the light source (e.g., the optical fiber 44) or the at least one objective lens 52 to be moved in the probe housing 42. This capability is provided, in the preferred embodiments, by forming the scanning mirror portions 48c and 48d with a first wall surface 48g that defines a deformable reflective membrane 48h (FIG. 7B) spaced apart from a base surface 48i. The reflective membrane 48h can be deformed by suitable actuators into a desired curvilinear surface that provides for adjustments of the focal point of the light beam extending from the at least one objective lens 52. For example, as shown in FIG. 7B, the reflective membrane 48h can be deformed into a generally parabolic shape to control the focus of the light beam from the optical fiber 44. An example of a similar reflective membrane 48h is shown and described in an International Patent Application filed under the Patent Cooperation Treaty, assigned Serial Number PCT/US04/01896, entitled “Off-Axis Variable Focus And Aberration Control Mirrors,” and filed in the United States Receiving Office on 26 Jan. 2004, which application is incorporated by reference in its entirety herein. And as used herein, the term “reflective” indicates some abilities to reflect light as compared to the incident light on the incident surface and is not limited to requiring the ability to reflect all of the light from the incident surface or uniformity in the reflectance across the incident surface.

The scanning mirror assembly 48 has several design features that are believed to be advantageous. The mirror 48a can include a base portion 48i and deformable portion 48h spaced apart along the central axis Z of the mirror 48a. The base portion has a first base surface 48k spaced apart from a second base surface 481 with a first wall portion 48n that connects the first and second base surfaces 48k and 481. The wall portion 48n forms a surface of revolution about the central axis to define a first aperture 56a. The deformable reflective membrane 48h includes a first surface 48h spaced apart from a second surface 48j along the central axis with a membrane wall portion 48m that connects the first and second membrane surfaces 48h and 48j. The second membrane wall portion forms a surface of revolution around the central axis to define a second aperture 56b generally aligned with the first aperture 56a through which light 60 from the terminal end 44b of the optical fiber 44 can be provided to the retro-reflecting mirror 52e. Consequently, the retro-reflecting mirror 52e can reflect the light beam back to the deformable reflective membrane 48h, which can be moved about at least two axes to provide for scanning of the light beam. Walls 48n and 48m defining apertures 56a and 56b could have other shapes that are not a surface of revolution about the central axis, for instance creating a rectangular or other polygonal aperture.

At least one actuator can be used to move the scanning mirror 48a about the axes and to deform the membrane 48h. Preferably, conductive surfaces 46e-46h can be provided on the planar surface of the ferrule 46 so that energization of the conductive surfaces 46e-46h causes the scanning mirror 48a to move. In this embodiment the mirror 48a and gimbal ring 48e form the counter electrode for electrostatic actuation. Movements of the scanning mirror 48a can be by thermo-electrical, electrostatic, or other suitable actuation techniques. In thermo-electrical actuation, heat can be generated by applying electrical current via the conductive surfaces 46e-46h to a resistive portion of the mirror 48a. This portion can have two different materials to provide for differential expansion and therefore movements of the mirror 48a. In electrostatic actuation, the mirror 48a can be connected to a ground state and separated from the conductive surfaces 46e-46h by a gap so that when a voltage is applied, the mirror 48a is attracted to the conductive surfaces 46e-46h, i.e., electrodes to provide for movements of the mirror 48a. In both arrangements, control of the movements of the mirror 48a can be obtained by open loop or closed-loop control. In open-loop control, it is assumed that the kinematic response by the scanning mirror 48a is within predictive parameters so that establishing the drive voltage defines the mirror position with sufficient accuracy for the application. In closed-loop control, the position of the scanning mirror 48a is independently monitored and this information is used as a feedback (e.g., proportional, integral, derivative or combinations thereof) signal that attempts to lock the motion of the scanning mirror 48a to the drive voltage waveform. One technique to monitor the position of the mirror 48a is to measure the capacitance between the scanning mirror 48a and the electrodes. This capacitance will vary with the angular position of the mirror 48a so that monitoring the capacitance fluctuation provides a generally direct monitoring of the mirror position. Another technique is to measure the strain on each of the beam members 49 with a suitable piezoelectric element micro-machined onto or into the beam members 49. A variety of other approaches are available to determine the mirror position, including optically monitoring the beam or intermittent monitoring of the position or amplitude. With a suitable controller for closed loop control, the control loop is capable of causing the mirror to virtually follow the drive voltage directly so that the controller is able to map the intensity of the drive voltage to the proper position of the scanning mirror 48a, without requiring the prediction of the mirror kinematics. Preferably, the actuation of the scanning mirror 48a for two-dimensional scanning is by electrostatic actuation via resonant (e.g., 1 kilo-Hertz or a suitable frequency) open loop control of at least one of the first or gimbaled members 48e or 48f, with damping provided by the air mass in the volume 46i between the scanning mirror 48a and the conductive surfaces 46e-46h (FIG. 6B). In the preferred embodiments, the actuators provide for about ±5′ of rotation of the mirror about each of the X and Y-axes.

To deform the surface of the deformable reflective membrane 48h into a desired curvilinear surface, electrostatic actuators can be used to achieve the desired surface configuration. In particular, the reflective surface 48h can be provided with two actuators A1 and A2 contiguous to the reflective surface 48h. In this embodiment the base portion 48i serves as a counter electrode for electrostatic actuation. The first actuator A1 can be formed to surround proximate a central portion of the reflective surface 48h with respective electrical connectors for electrical communication with an electromotive source. The second actuator A2 can surround the first actuator A1 and can be located proximate the outer perimeter of the scanning mirror 48a. The two actuators A1, A2 can be provided with differential voltages (e.g., different voltage levels) so that the surface 48h is deformed into a sectioned paraboloid surface along axis Z. By providing a fixed voltage to a centrally located actuator A1 of the deformable reflective membrane 48h, an outer actuator A2 can modify the curvature of the reflective membrane 48h through various curvatures as a function of a variable voltage. By adjusting the respective voltages of the two actuators, spherical aberration can be reduced, increased, or even eliminated. Specific techniques to control the scanning mirror assembly are shown and described in Yuhe Shao and David L. Dickensheets, “MEMS Three-Dimensional Scan Mirror,” SPIE Vol. 5348, pp. 175-183, Jan. 26-27, 2004, which is incorporated by reference in its entirety into this application.

The reflective surface 48h or portions of the reflective surface 48h can be moved to any suitable displacement along the central axis of the surface 48h (i.e., the Z-axis) and about the central axis Z from the center to the periphery of the surface 48h to provide a desired three-dimensionally curved reflecting surface. In the preferred embodiments, the maximum displacement of the reflective surface 48h can be 5 microns, and can be higher with suitable design of the membrane and its support. Alternatively, the two actuators can be provided with the same voltage such that both actuators can operate as a single actuator. Alternatively, more than two actuators may be used to provide greater control of the membrane shape. In the preferred embodiments, where the curved reflecting surface approximates a paraboloid, the range “dF” of focus adjustment can be approximated as:

$$dF = \frac{4 * δ}{{( NA )}^{2}}$$

where δ is the maximum displacement of the deformable reflective membrane and NA is the numerical aperture.

In a preferred embodiment, the maximum displacement δ of the deformable reflective membrane 48h is about 5 microns such that the range dF of focus adjustment is about 125 microns. Preferably, the focal length is about 6.1 or 12 millimeters to infinity.

The scanning mirror assembly 48 can be formed by micro-machining of a substrate, such as, for example, silicon. A thermal oxide layer can be disposed on the substrate. A sacrificial phosphosilicate glass layer is also provided over the thermal oxide and patterned to define the lateral extent of the air gap G. A silicon nitride layer can be formed on the phosphosilicate glass layer and thermal oxide layer. Contact openings can be patterned and etched through the silicon nitride and the underlying oxide, which can be followed by a phosphorus implant and anneal to establish electrical contact to the silicon substrate material in the region of the mirror 48a, gimbal ring 48e and support ring 48b. This electrical contact allows the silicon substrate material in the region of the mirror 48a and gimbal ring 48e to serve as a counter electrode for electrostatic actuation. A conducting layer can also be formed on the nitride layer and patterned to provide for a conductive and reflective surface 48h and specifically actuators A1 and A2, and to provide electrical connection to implant regions in the contact openings, and also provide traces for external connection to these various conducting structures. This conducting layer is preferably gold over a thin chromium layer. The mirror outlines and other structures can also be patterned and etched into the silicon nitride layer followed by an anisotropic silicon etch to define the mirror and gimbal ring structures. This anisotropic etch using a technique such as deep reactive ion etching may penetrate through the entire substrate. Alternatively this etch may penetrate a certain depth into the substrate, and a separate thinning etch may be applied to the back of the substrate to remove the bulk substrate material until the desired substrate thickness is achieved and the front side anisotropic etched features are then penetrating through the full thickness of the mirror plate 48a and gimbal ring 48e. A sacrificial oxide etching process is preferably provided to remove the glass layer. Preferably, the etching process utilizes an acid etching process such as, for example, hydro-fluoric acid. This etch removes the phosphosilicate glass (if such a layer is present) and also removes the thermal silicon dioxide under the nitride layer forming the membrane 48h. A subsequent anisotropic etching process, which can be a wet type such as potassium hydroxide or tetramethylammonium hydroxide, is preferably provided to remove some of the substrate layer to provide for the gap G between the deformable reflective membrane 48h and its substrate, and also will remove the substrate material from beneath the silicon nitride hinges 49. Alternatively, an isotropic wet etching process such as, for example, hydrofluoric, nitric and acetic acids (HNA) may be used to provide for the gap G and to remove the substrate material from beneath the hinges 49. Alternatively an isotropic dry etching process such as, for example, xenon difluoride vapor may be used to provide for the gap G and to remove the substrate material from beneath the hinges 49. Specific details of the unitary scanning mirror assembly, techniques for manufacturing and controlling the unitary scanning mirror are shown and described in Yuhe Shao and David L. Dickensheets, “MEMS Three-Dimensional Scan Mirror,” SPIE Vol. 5348, pp. 175-183, Jan. 26-27, 2004, which is incorporated by reference in its entirety into this application. Details for the fabrication of similar micro-machined mirrors are shown and described in International Patent Application No. PCT/US02/33351 (published as International Publication Number WO 03/036737A2 on 1 May 2003) filed in the United States Patent and Trademark Receiving Office on 21 Oct. 2002, which application is incorporated by reference into this application in its entirety herein. The general details for fabricating micro-machined deformable mirrors are well known to those skilled in the art. See, for example, U.S. Pat. Nos. 6,661,561; 6,656,768; 6,507,082; 6,398,372; 6,293,680; 6,236,490; 6,181,459; 6,108,121; 6,002,661; 5,986,795; 5,777,807; 5,661,592; 5,311,360; and David L. Dickensheets “Silicon-Micromachined Scanning Confocal Optical Microscope,” Journal of Microelectromechanical Systems, Vol. 7, No. 1, March 1998, all of which are herein incorporated by reference in their entirety.

In the preferred embodiments, the oxide layer of the mirror assembly 48 is about 100 nm thick, the glass layer is about 200 nanometers thick, the nitride layer is about 1 micron thick LPCVD low-stress silicon nitride with residual stress of between 50-100 MPa, and the metallic layer of the membrane 48h can be a sputtered-deposited layer of chromium of about 50 Angstroms thick and gold layer of about 1000 Angstroms thick. In the preferred embodiments, the topmost metal layer is patterned into two conductive members that define respective electrodes for an electrostatic actuator. As formed, the reflective membrane 48h has a gap G between the silicon nitride layer 48j and the base substrate material 48i FIG. 7B) of approximately 15 microns. The gap G can be preferably in communication with ambient air. This configuration has been demonstrated to provide a deflection of up to 5 microns for the deformable reflective membrane 48h while maintaining optical aberration of the reflected wavefront to less than twice the wavelength and preferably less than ⅕ of the wavelength, as measured at about λ=500 to 600 nm, respectively. Details of focus and aberration corrections of deformable mirrors are described in Phillip A. Himmer, David L. Dickensheets and Robert A. Friholm, “Micromachined silicon nitride deformable mirrors for focus control,” Optics Letters, Vol. 26, No. 16, pp 1280-1282, August 2001, which is incorporated in its entirety by reference herein.

Although the deformable reflective membrane 48h has been shown and described preferably as a unitary part of the scanning mirror 48a, it should be noted that the deformable reflective membrane 48h can be provided separately from the scanning mirror 48a at a different location in the confocal optical device while still maintaining the three-dimensional scanning capability. For example, the deformable reflective membrane 48h can be substituted for the retro-reflecting mirror 52a of the at least one objective lens 52 to separate the focusing from the scanning capabilities of the scanning mirror assembly 48. Consequently, the scanning mirror 48a can be formed to provide for a reflective surface that is fixed in a generally planar configuration (i.e., “non-deformable mirror”) instead of being deformable, and the at least one objective lens 52 can be provided with the deformable reflective membrane 48h whose surface deforms to change the focus of the at least one objective lens 52 along the longitudinal axis A-A. In an alternative preferred embodiment, this non-deformable scanning mirror can be located on the diffractive optical element 52a of at least one objective lens 52 while the deformable reflective membrane 48h can be mounted to the ferrule end cap 46c proximate the optical light source 44b.

Referring to FIG. 1, the moving of the scanning mirror 48a and the deforming of the reflective surface 48hs are preferably provided by the electronic interface 24 connected to the microprobe 40 by a multi-strand cable 54. The multi-strand cable 54 is connected to the respective actuators 46e-46h, A1, and A2, and the substrate of the scanning mirror assembly 48.

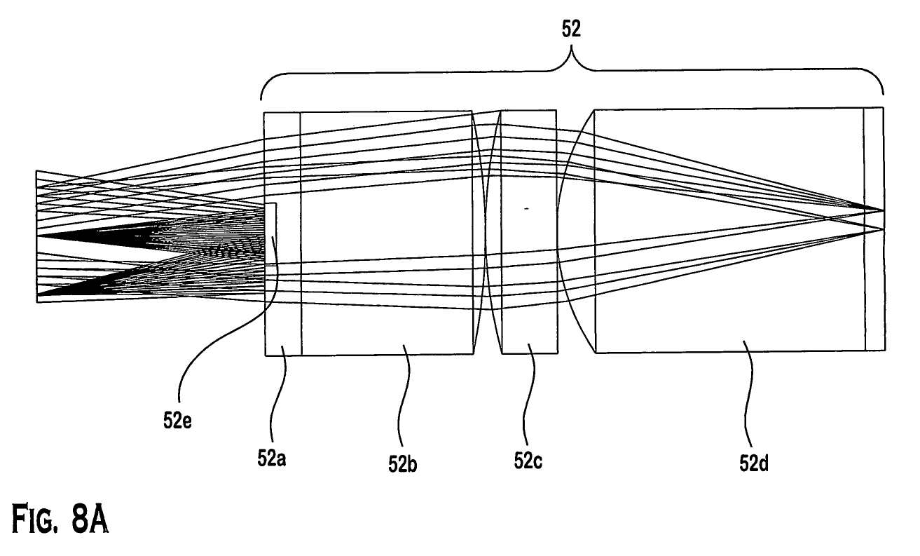

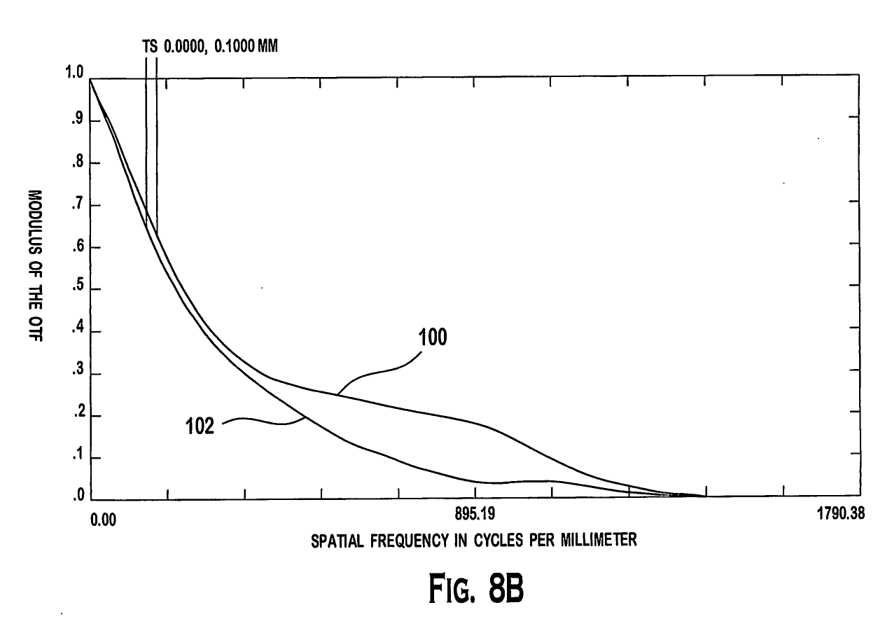

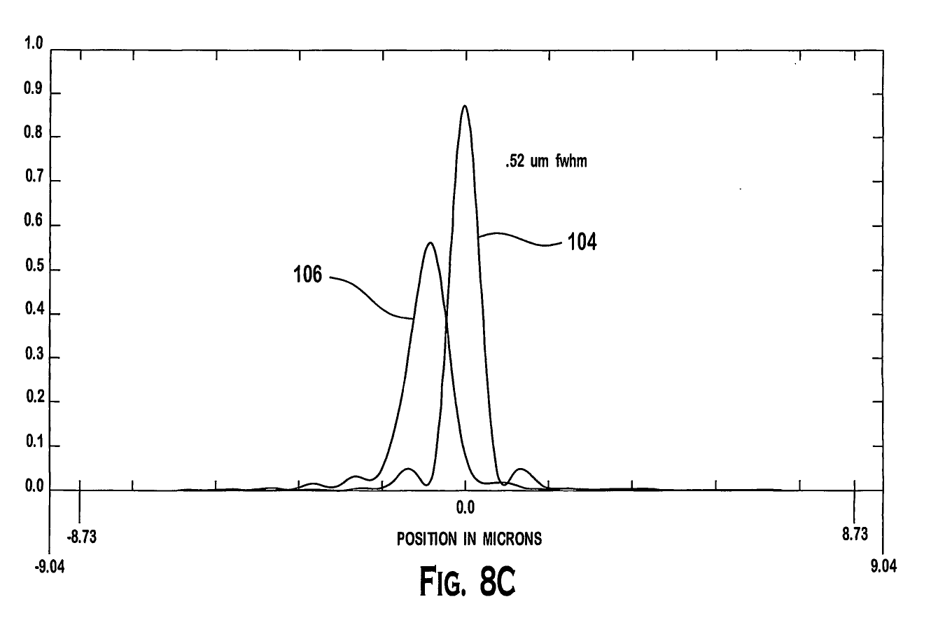

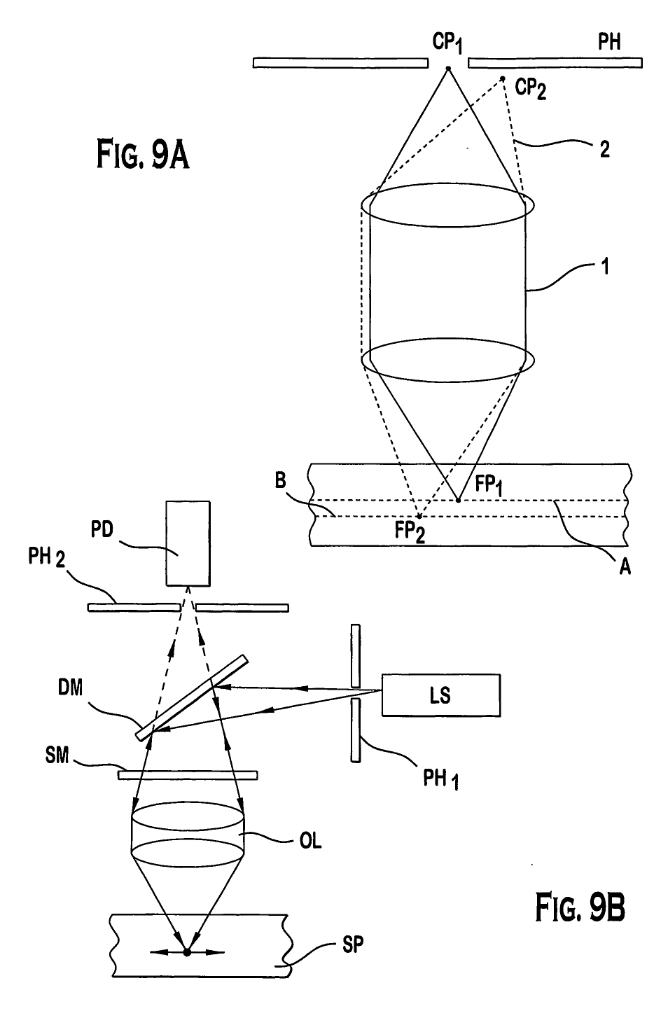

Referring to FIG. 8A, a preferred embodiment of the at least one objective lens 52 is shown. The at least one objective lens 52 can be a group of lenses that preferably is water immersable and when assembled with the microprobe 20, provides for four times the magnification of an object over a field of view of about 200 microns with a focal length of about 1 millimeter in air, a numerical aperture of about 0.4 for wavelength in the range of 400-600 nanometers. The group of lenses includes at least one diffractive optical element with at least one refractive optical element to provide for achromatization (e.g., correction of chromatic and spherical aberrations) of light through the at least one objective lens 52. Preferably, the group of lenses includes a diffractive optical element 52a made of pure silica glass and three refractive optical elements 52b, 52c, 52d made of BK7 (e.g., borosilicate crown) glass. The refractive optical elements 52b-52d preferably are plano-convex lenses, which are in contact with one another on the respective end faces of the lenses. The diffractive optical element 52a can also be assembled so as to contact one of the refractive optical elements 52b-52d so that the total length of the group of objective lens is about 5 millimeters. Where a shorter length of the objective lens 52 (and therefore the length of the housing 42) is desired, a higher index of refraction glass material such as, for example, diamond or sapphire, can be used. Alternatively, the objective lens 52 can be a single element lens or the lens 52 can be formed unitarily as a monolithic structure with the housing 42. In the preferred embodiments, the group of objective lenses 52a-52d are fixed to an inner wall of the housing 42, where the housing has a maximum cross-section area generally transverse to the longitudinal axis A-A of less than about 9 millimeter-squared. In another preferred embodiment, the group of objective lenses 52a-52d is fixed to the inner wall of the housing 42, where the housing has a maximum outside diameter of 1.5 millimeters. It is noted that the lenses are preferably circular in cross-section. And the preferred embodiment of the objective lenses, where the diameter of the lenses is taken to be 1.6 mm, is shown to relative scale in FIG. 8A such that, when appropriately scaled for the preferred embodiments, the objective lenses would operate, in conjunction with other components, to permit confocal imaging of objects. One skilled in the art can also determine the appropriate lens configuration based on selected parameters shown and described herein using conventional and commercially available optical design software.

Referring to FIG. 8B, an illustration of the contrast response of the preferred objective lens 52 is shown. Plot line 100 shows an acceptable contrast response of the objective lens 52 on its central axis beyond 1000 line pairs per millimeter. Plot line 102 shows the contrast response of the objective lens 52 at approximately 100 microns off-axis, which is also acceptable to beyond 1000 line pairs per millimeter.

Referring to FIG. 8C, an illustration of the resolution of the objective lens 52 is shown for two data; one on axis and one off-axis. As shown in the plot line 104, the width of the point spread function on-axis at half-maximum of the confocal response (width at 0.707 maximum of the plotted “one-way” point spread function) of the main lobe is believed to be acceptable at about 0.52 microns. As shown in the plot line 106, the width at half-maximum of the confocal response point spread function at about 100 microns off-axis is about 0.7 microns.

In operation, the confocal microprobe 40 is connected to the photodetection unit 20 via the optical fiber 44 and the optical interface 22. The tip of the housing 42 of the microprobe 40 can be placed proximate an appropriate specimen or object (not shown). Light is provided by the photodetector unit 20, which can be a commercially available unit, such as, for example, Leica CLSM Model NT. The light 60 generated in the photodetector unit 20 is transmitted through the optical interface 22 to the terminal end 44b of the optical fiber 44. Here, the light 60a is transmitted through the aperture 56 formed on the scanning mirror assembly 48 to reflect off the retro-reflecting mirror 52a formed on the objective lens 52 as a redirected beam of light 60b. The redirected beam of light 60b impinges on the deformable reflective membrane 48h to be reflected onto the objective lens 52 as an objective beam of light 60c. The objective beam of light 60c illuminates the object being scanned and depending on the application, Rayleigh scattered light or stokes-shifted light can be collected for respective brightfield or fluorescence imaging.

Based on the preferred embodiments described above, a method of controlling the focusing spot F1 of the probe 40 or to scan an object can be achieved. The method involves focusing control of the objective beam 60c or scanning control of the objective beam 60c at discrete intervals, overlapping intervals, or simultaneous time intervals. Specifically, focusing control can be performed via deformations of the reflective membrane 48h using differential electrostatic voltages supplied to the respective electrodes A1 and A2 so that the focusing spot F1 is translated along focal axis Z defined by the light beam to a different spot, such as, for example, F3. While focusing control is being performed on the objective beam, scanning control can also be performed by tilting the base 48i of the scanning mirror 48a about the respective orthogonal axes X-X and Y-Y so that the focusing spot F1 can translate laterally with respect to the focal axis Z to focusing spot F2. More particularly, the confocal microprobe 40 can scan in all three dimensions at a scan rate sufficient to view an object, such as for example, 24, 36, or 42 frames of the image of the object per second. Preferably, the confocal microprobe 40 can translate the focal point laterally along the X-Y plane with respect to the focal axis at a scanning rate of at least 1 kilo-Hertz, so that the scan rate is sufficient to produce at least 200 lines in a frame not exceeding 20 milliseconds. That is, the scanning mirror and objective lens can translate the focal point along a focal axis to scan an object at a scan rate of 20 kilo-Hertz. Other scan rates for both lateral and axial scanning are possible, including axial rates (focus adjustment) in excess of 100 kHz. Where the environment or object to be scanned is generally static over time, the scan rate can be arbitrarily selected to provide a sufficiently useful image. Also preferably, the deformable membrane 48h and actuators A1 and A2 (of the scanning mirror assembly 48) provide means for moving the light beam at a plurality of focal positions on a focal axis Z defined by the light beam. In particular, the scanning mirror assembly 48 with a non-deformable mirror (e.g., one whose surface is not selectively deformable to change its planar or curved surface) provides the means for scanning a light beam across a plane generally orthogonal to the focal axis Z. More preferably, the scanning mirror assembly 48 and the objective lens 52 provide the means for moving the light beam at a plurality of focal positions axially and laterally with respect to a focal axis Z defined by the light beam over a distance of about 100 microns.

Thus, the deformable reflective membrane 48h can place the objective beam at one of many desired focal points F1 and F3 along an initial focal axis Z (FIGS. 2 and 3) over a distance of 0-100 microns from the last glass surface of the objective lens 52. That is to say, depth scanning along the initial focal axis Z can be performed by controlling the deformable reflective membrane 48h. Lateral scanning (i.e., two-dimensional scanning), on the other hand, can be performed by laterally moving the focal point relative to the initial focal axis Z along orthogonal axes X and Y. Thus, three-dimensional scanning can be performed by a combination of lateral and depth scanning that can provide for three-dimensional imaging of objects.

Because of the ability of the preferred embodiments to move a focal point of a light beam in three dimensions without requiring movement of the scanned object, light source, or the objective optical lens to achieve the change in focal points, the device of the preferred embodiments is believed to be well-suited for three-dimensional imaging such as, for example, holographic displays, scanned light display with multiple focal planes, virtual retinal display, bar-code (or other symbology or character) scanning across non-planar surfaces, or three-dimensional optical signal processing, such as, for example, transmitting, reading, and writing into an optical surface (e.g., a Compact Disc or Digital Video Disc medium).

Additional applications of the preferred embodiments can be imaging (two or three-dimensional imaging) in various environments previously believed to be inaccessible, such as, for example, biofilms in natural environment including those of groundwater, nuclear storage facilities, internally and externally of the human body or its components. A discussion of each exemplary environment is provided below.

Biofilm Formation in Porous Media

One of the areas in which biofilms will be exploited, in a favorable sense, will certainly be in the manipulation of groundwater flow. Biofilms have the capability of blocking the passage of water through porous media, to the extent of a 99.5% blockage, and this strategy can be used to isolate pollutants in the subsurface or to block “breakthrough” zones in secondary oil recovery operations. It has been calculated that the selective plugging of the “stringers” that carry water from the injections wells used in secondary recovery, directly to the producer wells, will result in a 15% incremental increase in overall oil production. In terms of the US alone, this would add billions of gallons of oil to the reserves. Small commercial and large-scale pilot demonstrations of this technology have been carried out. A second use of the subsurface biofilm technology is in the provision of a very low cost “biobarrier” that binds closely with bedrock, and has the capability of forming an impenetrable barrier around pollutants that threaten groundwater sources. To this end, a very large scale demonstration project has been funded.

It is believed that a major difficulty encountered to date, in the subsurface biofilm area, has been the necessity of fine tuning various parameters, like flow rates and nutrient loading, in response to improvements in the performance of barriers formed over long periods in large scale lysimeters. It is believed that the performance of the barrier is based on the adhesion of bacterial cells to the surfaces surrounding pores in porous materials, and on the amount of matrix material that the adherent cells make in response to the nutrient made available. However, it is believed that there is no currently available way of quantifying either the adhesion of cells or the production of matrix material within the pore spaces that the biofilm is attempting to block, and it is suspected that both values are heterogeneous in different parts of the porous medium. In one prospective configuration, the confocal microprobe according to one of the preferred embodiments would be introduced via a medical style trochar into different locations in the porous medium. The captured image would enable an observer to visualize the extent to which bacterial cells are present, the extent to which they are associated with the surfaces of particles, and the amount of matrix material that they have made in this location. The confocal probe of the preferred embodiments may also assist in monitoring bacterial activities in hard-to-reach areas of the subsurface in which the presence and activity of bacteria are a major factor, including bioremediation operations, because the use of the probe can be combined with chemical probes for cell activities.

Nuclear Storage Facilities

Until the Yucca Mountain nuclear storage facility in Nevada comes on line, many Department of Energy facilities are forced to store increasing amounts of nuclear wastes in wet storage facilities, and several of these operations have reported problems with biofouling and with Microbially Influenced Corrosion (MIC). It is believed that a large contract for a theoretical study of the functional link between biofilm formation on metal surfaces and the initiation of MIC has been initiated, but access to the actual facilities is limited because of radiation safety issues. Boroscopes are available for low magnification examinations of these facilities, and these instruments give excellent data on water turbidity and on the initiation of corrosion pits in the metal surfaces. However, water turbidity and pit formation are late stage symptoms of serious trouble, and what is needed is accurate data on the extent of biofilm formation on these surfaces, because it is these biofilms that initiate MIC and metal failures. It is believed that a confocal probe according to one of the preferred embodiments could be kept in a particular facility, with good capability for movement and the examination of many surfaces, and with a safe interface with a standard mobile instrument package for confocal interpretation and image analysis. Where the preferred confocal probe stays stationary in an aquatic ecosystem, it will acquire the same adherent biofilm that will form on all available surfaces, but the probe can be removed from the system and cleaned, and then introduced to a statistically significant number of surface sites to make accurate determinations of biofilm thickness.

Mixed Species Biofilms in Natural Environments

It is believed to be very difficult to establish a mixed species biofilm, such as one that might occupy the gingival crevice in the healthy mouth, in a flow cell for use with a conventional confocal microscope. Some workers have developed multispecies biofilms, comprised of as many as 8 species, but these artificial biofilms cannot be thought to represent the very complex and very mechanically strong subgingival plaque actually seen in this location. Similarly, the steady flow of the gingival fluid is difficult to model in a flow cell, and the local perturbations of flow caused by such operations as gingival cleaning are impossible to replicate in a flow cell. The gingival crevice represents one of the most extensive zones of contact between bacteria and tissues in the human body, and the maintenance of health requires that the inflammation that results from such juxtaposition is minimized. In this important natural ecosystem the actual mode of growth of the bacteria is of pivotal importance, because planktonic (floating) cells are different from biofilm cells and are much more irritating to tissues, while biofilms are resistant to clearance but not normally prone to cause inflammation.

Another natural microbial population, with equally ready access for instrumentation, grows in the human vagina and the mode of growth of these normal organisms is of equal or greater importance. Microbial Ecologists who study human systems are sufficiently interested in the chemical conditions in both of these ecosystems that they have made many series of crude measurements of pH and oxygen tension, using instruments many millimeters in diameter, especially recently in the vaginal system. It is believed that the confocal probe according to the preferred embodiments can resolve bacterial cells in vivo, without recourse to fluorescent staining. One question that is believed to be answered will be the predominant mode of growth of the bacterial cells, in the planktonic form or the biofilm form, and another will be the extent to which the tissue surfaces are actually occluded by the bacterial biofilms. Where fluorescent and other chemical type confocal probes according to the preferred embodiments can be used to visualize the bacteria, well known animal surrogates for the human systems (the baboon for the vagina and the beagle dog for the dental work) may be used, and complete mapping of the bacterial populations of both systems could be possible. More importantly, the microbial map can be linked to a map of the chemical heterogeneity caused by the formation of special loci within the biofilm. Hence, it is believed that one can determine exactly what the colonized tissue “see” with respect to the bacteria. It is believed that the direct visualization of bacterial biofilms on tissue surfaces in colonized organ systems will lead to spectacular progress in this field.

Study of Biofilm Processes on Tissue Surfaces

It is a characteristic of biofilms that they are particularly resistant to antibacterial agents that easily destroy their planktonic counterparts. One of the most important of these antibacterial factors are the phagocytic cells that attempt to engulf bacteria in nature (amoebae) and in the body (neutrophils), and crude studies in flow cells have shown that biofilms are very well protected from these phagocytes. These in vitro flow cell studies are not representative of natural encounters between biofilms and phagocytes, because the biofilms are formed on glass surfaces and the menstruum in which the challenge takes place is an artificial solution (physiological saline). The actual process in the body occurs on the surface of a tissue, like the endothelium of a blood vessel, and takes place in whole blood. For these reasons, the flow cell experiments are not really representative of reality and the confocal microprobe of the preferred embodiments would allow real-time imaging of the internal environments of the human body.

It is believed that the microprobe of the preferred embodiments can be placed in a blood vessel of an animal that has been induced to form bacterial biofilms by the catheter scarring technique used to induce endocarditis. The confocal probe would be manipulated in the lumen of a suitable vessel, and the general process could be guided by fluoroscopy, until a bacterial biofilm was located on the endothelial surface. The inflammatory process in the tissue adjacent to the biofilm could be detected by histological changes, the cytokine response of the animal could be monitored by many available techniques, and the platelet response could readily be visualized by the confocal microprobe. Following the platelet response, which occurs very quickly, it is anticipated that the integrin-directed attack of polymorphonuclear leucocytes (PMNs) and a recording of both the attack and its efficacy in killing or removing the bacterial cells within the biofilm. Removal would be monitored microscopically, and the killing would be determined by the “live-dead” stains that are believed to be used in conjunction with the conventional confocal microscope. The confocal microprobe of the preferred embodiments would provide the capability of examining a biofilm process, such as the profound resistance of biofilm bacteria to phagocytosis, on a tissue surface in an intact blood vessel in serum. This is believed to represent a huge advance on the present method of examining the same process on a flat glass surface in physiological saline, and many other biofilm process would be much more realistically modeled based on the preferred embodiments of the confocal microprobe.

In-Vivo Optical Biopsy

One area of particular interest for a miniature confocal optical microscope is direct imaging with cellular resolution of intact tissues for the purpose of determining disease state of the tissue. This is referred to as optical biopsy. Because confocal microscopy can image to a depth beneath the surface of intact tissue, important features such as cell size, nuclear size, nuclear-cytoplasm ratios and other morphologic features may be obtained for cells near the surface and at depth. This will allow the differentiation of healthy and diseased cells, such as for cancer or pre-cancer detection, and for determination of margins of cancerous lesions. A miniature microscope will allow microscopic examination on the surface of the body or inside the body using specialized probes, catheters, endoscopes, needles and other delivery tools necessary to introduce the microscope adjacent to the tissue to be imaged. Combining brightfield and fluorescence imaging in a single probe as described herein allows for imaging of structures with contrast provided by differences in index of refraction, amount of autofluorescence, and fluorescence caused by exogenous markers. Both research and clinical applications of in-vivo optical biopsy are believed to be practicable based on appropriate application of the preferred embodiments.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth and as follows in the scope of the appended claims.

What is claimed is:

1. A device comprising:
a light source;
at least one objective lens proximate the light source;
a unitary member proximate the light source having an outer portion and an inner portion, the inner portion connected to the outer portion, the inner portion having a deformable surface; and
at least one actuator that is configured to: (1) deform at least a portion of the deformable surface into a curved sectional surface; and (2) move the inner portion relative to the outer portion upon energization of the at least one actuator.

2. A device comprising:
a light source;
at least one objective lens proximate the light source;
a unitary member proximate the light source having an outer portion and an inner portion, the inner portion connected to the outer portion, the outer portion having a maximum cross-sectional area of less than about 9 squared millimeters, the inner portion having a deformable surface; and
at least one actuator that is configured to: (1) deform at least a portion of the deformable surface into a curved sectional surface; and (2) move the inner portion relative to the outer portion upon energization of the at least one actuator.

3. A device comprising:
a housing extending along a longitudinal axis between first and second ends;
a light source transmitting a light beam towards the second end;
at least one objective lens disposed in the housing proximate the second end, the at least one objective lens having a reflective portion that directs the light beam from the light source towards the first end; and
a member disposed between the light source and the at least one objective lens, the member having a reflective portion that defines a curved surface with respect to the longitudinal axis in an operative position of the member.

4. A device comprising:
a housing;
a light source providing a light beam; and
means for moving the light beam to a plurality of focal positions laterally and axially on a focal axis defined by the light beam.

5. A device comprising:
a housing extending along a longitudinal axis between first and second ends;
a light source transmitting a light beam towards the second end, the light source being fixed at a first location in the housing;
at least one objective lens; and
a member disposed between the light source and the at least one objective lens, the member having a deformable reflective portion that directs the beam through the at least one objective lens to define a first focal point of light away from the housing along a focal axis in a first operative position of the deformable reflective portion and define a second focal point of light on the focal axis in a second operative position of the deformable reflective portion.

6. A device comprising:
a housing extending along a longitudinal axis between first and second ends;
a light source transmitting a light beam towards the second end, the light source being fixed at a first location in the housing;
at least one objective lens disposed at a fixed location in the housing proximate the second end; and
a member proximate the second end, the member having a deformable reflective portion that reflects the directed beam through the at least one objective lens to define a first focal point of light away from the housing on a focal axis defined by the directed beam in a first operative position of the deformable reflective member, and a second focal point of light on the focal axis in a second operative position of the deformable reflective member.

7. A device comprising:
a housing extending along a longitudinal axis between first and second ends, the housing having a maximum cross-sectional area with respect to the longitudinal axis of less than about 9 millimeters-squared;
a light source providing a light beam; and
means for moving the light beam to first and second focal points on a focal axis defined by the beam of light.

8. A device comprising:
a housing extending along a longitudinal axis between first and second ends, the housing having a maximum cross-sectional area with respect to the longitudinal axis of less than about 9 millimeters-squared;
a light source transmitting a light beam towards the second end; and
at least one objective lens disposed in the housing proximate the second end, the at least one objective lens including one diffractive lens and one refractive lens.

9. A device comprising:
an input portion, the input portion transmitting a light beam through the input portion;
a focusing portion that moves the light beam at a plurality of focal positions on a focal axis defined by the light beam; and
a housing extending along a longitudinal axis between first and second ends to enclose the input and focusing portions, the housing having a maximum cross-sectional area with respect to the longitudinal axis of less than about 9 millimeters-squared.

10. The device of any one of claims 3, 4, and 6, wherein the housing comprises a housing having a maximum cross-sectional area with respect to the longitudinal axis of less than about 9 millimeters-squared.

11. The device of any one of claims 3-6, wherein the housing comprises an outer diameter as measured generally transverse to the longitudinal axis of about 1.8 millimeters and extending about 10 millimeters along the longitudinal axis.

12. The device of any one of claims 3-6, wherein the housing comprises an outer diameter as measured generally transverse to the longitudinal axis of about 1.5 millimeters and extending about 10 millimeters along the longitudinal axis.

13. The device of claim 10, wherein the light source, objective lens, and housing are in a fixed relationship.

14. The device in any one of claims 1 and 2, wherein the unitary member comprises a support portion connected to the reflective portion at first and second locations on the support portion that define a tilting axis extending between the first and second locations, the reflective portion having at least a first actuator coupled to the reflective portion to rotate the reflective portion about the tilting axis when at least the first actuator is energized, the reflective portion including at least a second actuator coupled to a surface of the reflective portion to deform the surface towards the light source when at least the second actuator is energized.

15. The device of claim 14, wherein the unitary member comprises at least a third actuator coupled to the reflective portion to rotate the reflective portion relative to the support portion about a tipping axis extending between third and fourth locations when at least the third actuator is energized.

16. The device in any one of claims 3, 5, and 6, wherein the member comprises
a first member mounted to the at least one objective lens, the first member having a generally planar wall portion with a reflective surface that reflects the light beam towards the first end, the wall portion being coupled to at least a first actuator so that upon energization of at least the first actuator, the reflective surface of the wall portion is deformed into a curved reflective surface; and
a second member located between the point light source and the at least one objective lens, the second member including a support portion connected to a reflective portion at first and second locations on the support portion that define a tilting axis extending between the first and second locations, the support portion connected to the reflective portion at a third and fourth locations on the support portion that define a tipping axis, the member having at least a second actuator coupled to the reflective portion to rotate the reflective portion about the tilting axis when at least the second actuator is energized, and at least at least a third actuator coupled to the reflective portion to rotate the reflective portion about the tipping axis when at least the third actuator is energized.

17. The device of claim 16, wherein the tipping axis comprises an axis generally orthogonal to the tilting axis.

18. The device of claim 16, further comprising a base structure disposed in the housing proximate the first end.

19. The device of claim 18, wherein the base structure comprises a ceramic structure having first and second end caps spaced along the longitudinal axis, the ceramic structure having a wall portion connecting the end caps, the wall portion having a wall surface defining an aperture extending through the ceramic structure on the longitudinal axis.

20. The device of claim 19, wherein the ceramic structure comprises an outer surface having at least a curved surface intersecting at least a planar surface to define a D-shaped cross-section, the curved surface and at least a planar surface extending along the longitudinal axis.

21. The device of claim 20, wherein one of the first and second end caps comprises a planar surface generally transverse to the longitudinal axis on which at least the second and third actuators are located thereon.

22. The device of claim 21, wherein the first, second, and third actuators comprise an electrostatic actuator.

23. The device in any one of claims 1-8, wherein the light source comprises a high-intensity light coupled to an optical fiber extending along the longitudinal axis in the housing to transmit at least one light beam bi-directionally along the length of the optical fiber.

24. The device of claim 23, wherein the optical fiber comprises a single-mode optical fiber that transmits the light beam having a wavelength of about 500 nanometers.

25. The device of claim 23, wherein the optical fiber comprises a single-mode optical fiber extending generally parallel and offset to the longitudinal axis.

26. The device in any one of claims 1-3, 5, 6, and 8, wherein the objective lens comprises at least one diffractive optical element and at least one refractive optical element.

27. The device in any one of claims 1 and 2, wherein the at least one actuator comprises at least one actuator configured to rotate the inner portion relative to the outer portion upon energization of the at least one actuator.

28. The device of claim 21, wherein the at least one refractive optical element comprises three plano-convex optical elements stacked along the longitudinal axis to provide for a numerical aperture of about 0.4 and a focal length of about 1 millimeter.

29. The device of claims 3, 5, and 6, wherein the member comprises a base surface spaced apart from the reflective portion along the longitudinal axis, the base surface having a wall portion extending through the base surface to define a first aperture, the reflective portion having a wall portion extending through the reflective portion to define a second aperture, the first and second aperture being aligned to pass light through the base surface and the reflective portion.

30. The device in any one of claims 3-6, wherein the housing, light source, member, and objective lens are symmetric about the longitudinal axis, the housing having an outer diameter of about 1.8 millimeters and extending about 10 millimeters along the longitudinal axis.

31. The device in any one of claims 3, 4, 5, and 6, wherein the housing, light source, member, and objective lens are symmetric about the longitudinal axis, the housing having an outer diameter of about 1.5 millimeters and extending about 10 millimeters along the longitudinal axis.

32. The device of claim 16, wherein the objective lens comprises at least one diffractive optical element and three plano-convex optical elements stacked along the longitudinal axis, and the first member is mounted on the at least one diffractive optical element.

33. The device of claim 8, wherein the at least one objective lens comprises an objective lens configured to transmit at least one of invisible and visible lights.

34. The device of claim 33, wherein the at least one refractive lens comprises three plano-convex lenses with each lens in contact with at least one other plano-convex lens to provide for lateral chromatic shift of less than 1 micron, axial chromatic shift of less than 4 microns for wavelength of light from 480 nanometers to 600 nanometers,

35. The device of claim 33, wherein the at least one refractive lens comprises three plano-convex lenses with each lens in contact with at least one other plano-convex lens to provide for a contrast response of 1000 line pairs per millimeter with on-axis confocal point spread of about 0.52 micron at full width half-maximum of the main lobe of a graphical representation of an Airy disc.

36. The device of claim 8, wherein the at least one refractive lens comprises three plano-convex lenses with each lens in contact with at least one other plano-convex lens to provide for lateral chromatic shift of less than 1 micron, axial chromatic shift of less than 4 microns for wavelength of light from 480 nanometers to 600 nanometers, contrast response of 1000 line pairs per millimeter with on-axis confocal point spread of about 0.52 micron at full width half-maximum of the main lobe of a graphical representation of an Airy disc.

37. The device of claim 8, further comprising means for focusing a beam of light extending from the at least one objective lenses to first and second focal points on a focal axis defined by the beam of light.

38. The device of any one of claims 7 and 37, wherein the means comprise means for scanning the light beam to at least other focal points lateral to the focal axis defined by the light beam.

39. The device of claim 8, further comprising a member disposed between the light source and the at least one objective lenses, the member having a deformable reflective portion that reflects the directed beam through the at least one objective lenses to define a first focal point of light away from the housing along a focal axis in a first operative position of the deformable reflective member, and a second focal point of light on the focal axis in a second operative position of the deformable reflective member.

40. The device in any one of claims 3, 5, and 6, wherein the member comprises a support portion connected to the reflective portion at first and second locations on the support portion that define a tilting axis extending between the first and second locations, the reflective portion having at least a first actuator coupled to the reflective portion to rotate the reflective portion about the tilting axis when at least the first actuator is energized, the reflective portion including at least a second actuator coupled to a wall of the reflective portion to deform the wall towards the light source when at least the second actuator is energized, and at least a third actuator coupled to the reflective portion to rotate the reflective portion relative to the support portion about a tipping axis extending between third and fourth locations when at least the third actuator is energized.

41. The device in any one of claims 2, 3, 5, and 6, wherein the at least one objective lens comprises a diffractive lens, the diffractive lens including a reflective portion that directs the light beam from the light source towards the first end of the housing.

42. The device in any one of claims 1-4, wherein the housing is disposed in an environment to obtain an image from the environment, the environment selected from a group comprising one of a biofilm in porous media; nuclear storage facilities; internally in the human body; and externally on the surface of the human body.

43. A dynamic lens comprising:
a unitary member having an outer portion and an inner portion, the inner portion connected to the outer portion, the inner portion having a deformable surface;
at least one actuator that: (1) deforms at least a portion of the deformable surface into a curved sectional surface; and (2) moves the inner portion relative to the outer portion upon energization of the at least the one actuator.

44. The dynamic lens of claim 43, wherein the maximum cross-sectional area of unitary member is less than 3 millimeters squared.

45. A dynamic lens comprising:
an outer portion;
an optical inner portion connected to the outer portion, the optical inner portion having a base portion and deformable portion spaced apart along an axis, the base portion including a first base surface spaced apart from a second base surface with a first wall portion connecting the first and second base surfaces, the wall portion being disposed about the axis to define a first aperture, the deformable portion including a first surface spaced apart from a second surface along the axis with a second wall portion connecting the first and second surfaces, the second wall portion being disposed around the axis to define a second aperture generally aligned with the first aperture; and
at least one actuator contiguous to the first surface of the deformable portion so that energization of at least the one actuator deforms the first surface into a curved solid sectional surface.

46. The dynamic lens of claim 45, wherein the outer portion comprises a first annular member surrounding the inner portion, the first annular member having first diametrically disposed beam members connecting first annular member to the inner portion to permit rotation of the inner member about a tilting axis generally orthogonal to the axis.

47. The dynamic lens of claim 45, wherein the outer portion comprises a second annular member surrounding the first annular member, the second annular member having second diametrically disposed beam members connecting the second annular member to the first annular member to permit rotation of the first annular member about a tipping axis generally orthogonal to the tilting axis.

48. The dynamic lens of claim 45, further comprising at least another actuator coupled to the inner portion to rotate the inner portion about one of the tilting and tipping axes when at least the another actuator is energized.

49. The dynamic lens of claim 45, wherein the first surface comprises a reflective surface.

50. A confocal optical system comprising:
a photodetector that generates signals to a graphical display based on detection of light;
a light source;
an optical fiber having a first end and a second end, the first end in communication with the light source; and
a confocal optical probe in communication with the light source, the confocal optical probe including:
a housing extending along a longitudinal axis between first and second ends, the housing having a maximum cross-sectional area with respect to the longitudinal axis of less than about 9 millimeters-squared;
a base structure connected to the second end of the optical fiber, the base structure extending along the longitudinal axis in the housing and locating the second end of the optical fiber at a fixed location in relation to the housing; and
at least one objective lens located in the housing in a fixed position proximate the second end, the at least one objective lens having a reflective portion that directs a light beam of the light source through the optical fiber towards the first end of the housing as a directed beam of light.

51. The system of claim 50, further comprising means for establishing a first focal point and a second focal point of the directed beam of light extending from the at least one objective lens on a focal axis.

52. The system of claim 51, further comprising a member disposed between the light source and the at least one objective lenses, the member having a deformable reflective portion that reflects the directed beam through the at least one objective lenses to define a first focal point of light away from the housing along a focal axis in a first operative position of the deformable reflective member, and to define a second focal point of light on the focal axis in a second operative position of the deformable reflective member.

53. The system of claim 52, wherein the member defines a plurality of focal points along the focal axis over a distance of 100 microns at a repetition rate of greater than 1 kilo-Hertz.

54. The system of claim 51, wherein the confocal optical probe is adapted to capture an image from an environment selected from a group comprising one of a biofilm in porous media; nuclear storage facilities; internally in the human body; and externally on the surface of the human body.

55. The system of claim 52, wherein the housing includes an outer diameter as measured generally transverse to the longitudinal axis of about 1.8 millimeters and the housing extends about 10 millimeters along the longitudinal axis.

55. The system of claim 52, wherein the housing includes an outer diameter as measured generally transverse to the longitudinal axis of about 1.5 millimeters and the housing extends about 10 millimeters along the longitudinal axis.

56. A method of controlling a focus of an optical device, the method comprising:
providing a light source with an objective lens fixed in relation to each other and a housing so that a light beam from the light source along a longitudinal axis converges through the objective lens to a focal point on a focal axis; and
translating the focal point along the focal axis.

57. The method of claim 56, wherein the translating comprises moving the focal point laterally relative to the focal axis.

58. The method of claim 56, further comprising moving the focal point laterally relative to the focal axis.

59. A method of scanning an object, the method comprising:
establishing a fixed relationship between a light source, objective lens and a housing of an optical device so that a light beam from the light source converges through the objective lens to a focal point along a focal axis;
translating the focal point along the focal axis during a first time interval.

60. The method of claim 59, wherein the translating comprises moving the focal point laterally relative to the focal axis during a second time interval that overlaps the first time interval.

61. The method in any one of claims 56 and 59, wherein the translating comprises translating the focal along the focal axis at a repetition rate of about 1 kilo-Hertz.

62. The method in claim 61, wherein the translating comprises translating the focal point along the focal axis at a repetition rate sufficient to provide for 200 lines in a frame of about 20 milliseconds.

63. The method in any one of claims 57 and 60, wherein the moving comprises moving the focal point laterally with respect to the focal axis at a repetition rate of 1 kilo-Hertz.

64. The method in claim 63, wherein the translating comprises translating the focal point along the focal axis at a repetition rate sufficient to provide for 200 lines in a frame of about 20 milliseconds.

65. The method of claim 64, further comprising moving the focal point laterally relative to focal axis during a second time interval that overlaps the first time interval.
